(19) United States
(12) Patent Application Publication
(10) Pub. No.: US 2008/0222185 A1
(43) Pub. Date: Sep. 11, 2008

(54) SYSTEM AND METHOD FOR GENERATING EVENT RELATED DOCUMENT OUTPUT

(76) Inventors: William Su, Riverside, CA (US); Giri Natarajan, La Palma, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/684,374

(22) Filed: Mar. 9, 2007

(51) Int. Cl. G06F 17/30

(52) U.S. Cl. 707/102

(57) ABSTRACT

The subject application is directed to a system and method for generating date range related document output. User identification data is first received by a document processing device corresponding to an associated user. The user then requests the generation of a date range related document via a user interface associated with the device. Data range related content data, and corresponding pricing data, are then received from an associated storage. A display is then generated via the user interface corresponding to the received content data and the received pricing data. The user then selects desired content data, which is used to generate a data range document. The cost associated with generating the date range related document is then generated. The data range related document, upon receipt of cost authorization, is then rendered by the associated document processing device.

### BACKGROUND OF THE INVENTION

The subject application is directed to a system and method for generating date range related document output. The application is directed to a system and method for generating seasonal or calendar date related document output.

Document processing devices, such as printers, facsimile machines, or other document output devices, as well as multifunction peripherals that include more than one of these functions are constantly being improved relative to the array of available functions.

More recently, document processing devices are becoming available in common areas, such as hotels, lobbies, airports, train stations, retail establishments, or any other suitable public or high-traffic location. A suitable mechanism for shared access to publicly available document processing devices is in the form of a kiosk that includes functionality, such as that noted above. A user suitably accesses the kiosk through a wireless or wired data transfer mechanism, and uses the functionality to print a document, send a facsimile transmission, and send an e-mail or other electronic or hard copy output. Devices typically include a mechanism to secure payment for use of requested document processing functionality.

Conventional kiosk operation is limited to standard document processing operations, such as those noted above.

### SUMMARY OF THE INVENTION

In accordance with one embodiment of the subject application, there is provided a system and method for generating date range related document output.

Further, in accordance with one embodiment of the subject application, there is provided a system and method for generating seasonal or calendar date related document output.

Still further, in accordance with one embodiment of the subject application, there is provided a system for generating date range related document output. The system comprises means adapted for receiving identification data corresponding to an associated user and means adapted for receiving a request from the associated user for generation of a date range related document. The system further comprises means adapted for receiving date range related content data from an associated storage and means adapted for receiving pricing data associated with received content data. The system also comprises means adapted for generating display data inclusive of a display corresponding to received content data and received pricing data and means adapted for receiving selection data corresponding to the content data from the associated user. The system further includes means adapted for generating a date range document in accordance with received selection data, means adapted for generating cost data in accordance with received selection data, and rendering means adapted for rendering the date range related document.

In one embodiment of the subject application, the content data includes at least one of data from the set comprising of image data and text data, and which data is associated with a selected date range. In one such embodiment, the selected date range corresponds to a holiday. In another embodiment, the selected date range corresponds to calendar data.

In a further embodiment of the subject application, the system further comprises means adapted for generating a display in accordance with generated cost data, means adapted for receiving authorization data, and means adapted for enabling the rendering means in accordance with received authorization data. Preferably, the authorization data is received from at least one of the associated user and an associated financial institution.

Still further, in accordance with one embodiment of the subject application, there is provided a method for generating date range related document output in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of the system for generating date range related document output according to one embodiment of the subject application;

FIG. 2 is a block diagram illustrating device hardware for use in the system for generating date range related document output according to one embodiment of the subject application;

FIG. 3 is a functional diagram illustrating the device for use in the system for generating date range related document output according to one embodiment of the subject application;

FIG. 4 is a block diagram illustrating controller hardware for use in the system for generating date range related document output according to one embodiment of the subject application;

FIG. 5 is a functional diagram illustrating the controller for use in the system for generating date range related document output according to one embodiment of the subject application;

FIG. 6 is a block diagram illustrating a server for use in the system for generating date range related document output according to one embodiment of the subject application;

FIG. 7 is a flowchart illustrating a method for generating date range related document output according to one embodiment of the subject application; and

FIG. 8 is a flowchart illustrating a method for generating date range related document output according to one embodiment of the subject application.

### DETAILED DESCRIPTION OF THE PREFERRED EMBODIMENT

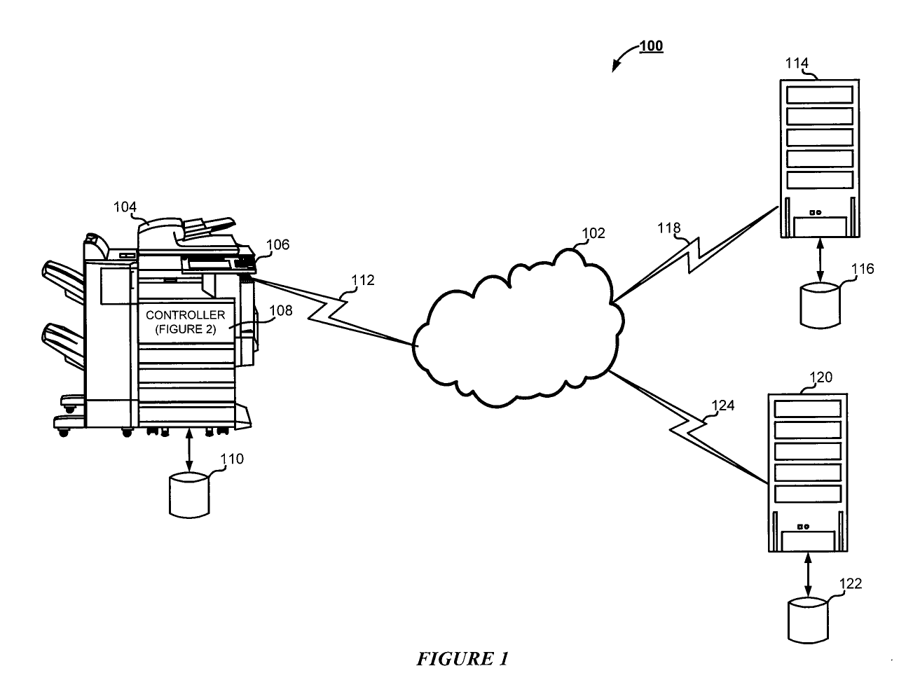

The subject application is directed to a system and method for generating date range related document output. In particular, the subject application is directed to a system and method for generating seasonal or calendar date related document output. It will become apparent to those skilled in the art that the system and method described herein are suitably adapted to a plurality of varying electronic fields employing customized output creation, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of the system 100 for generating date range related document output in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

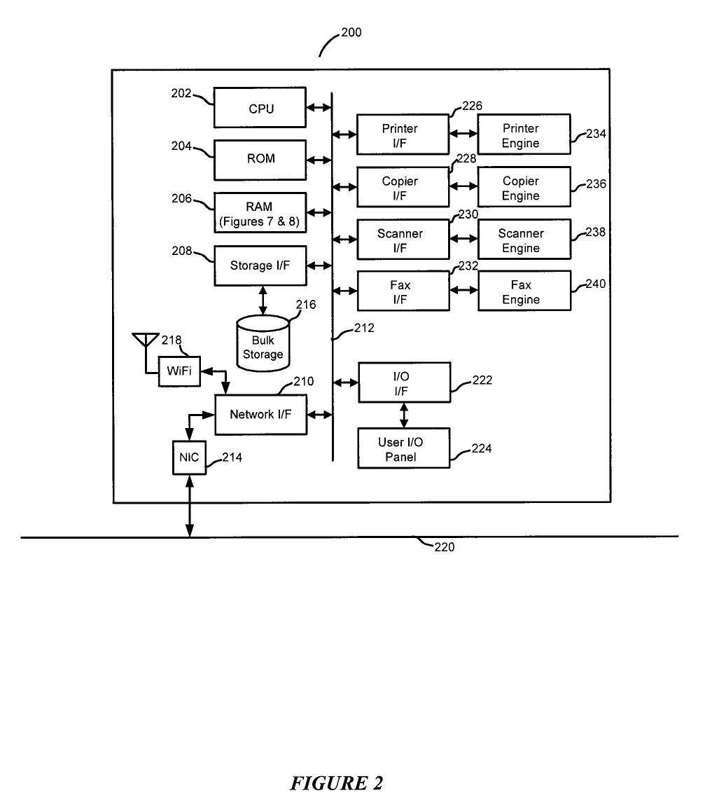

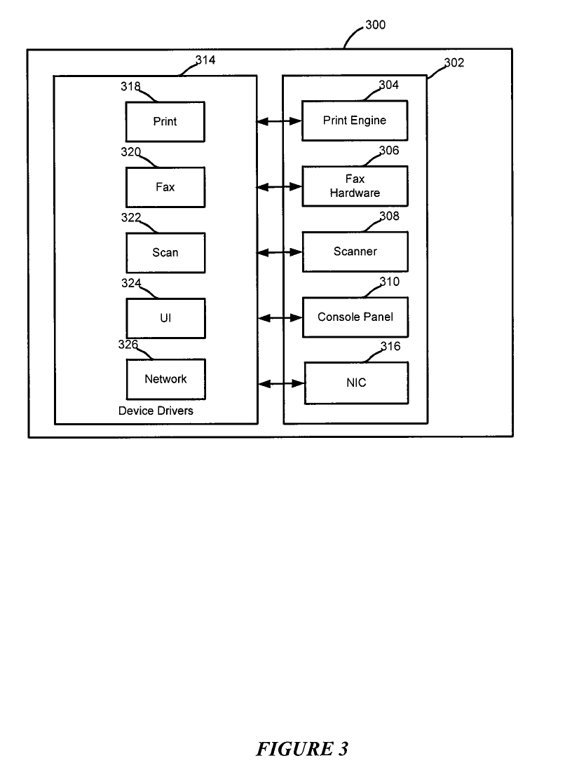

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like. The functioning of the document processing device 104 will better be understood in conjunction with the block diagrams illustrated in FIGS. 2 and 3, explained in greater detail below.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

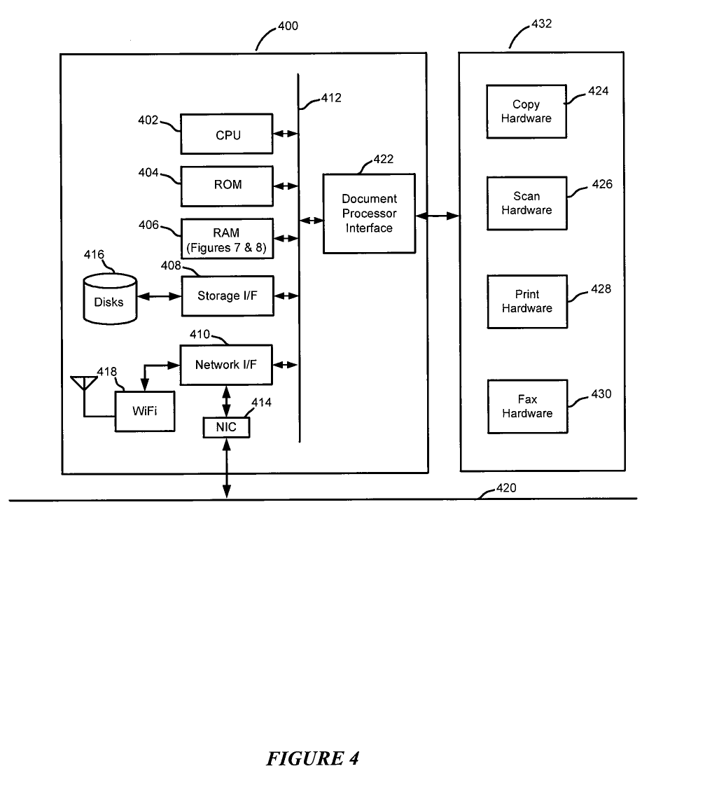

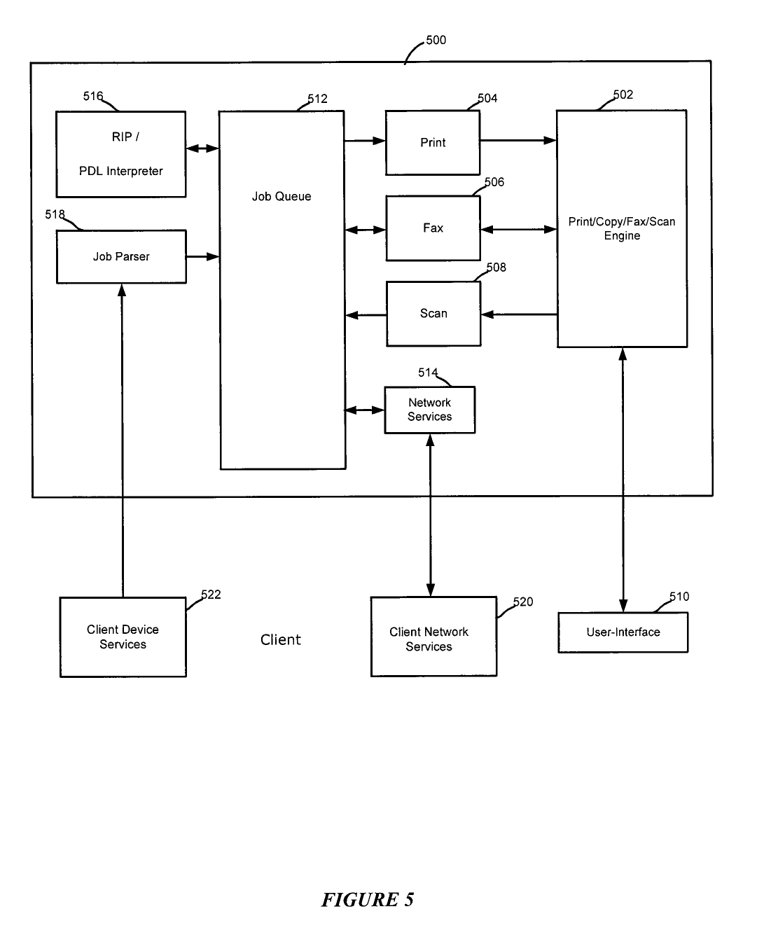

In accordance with one embodiment of the subject application, the document processing device 104 further incorporates a backend component, designated as the controller is 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for generating date range related document output of the subject application. The functioning of the controller 108 will better be understood in conjunction with the block diagrams illustrated in FIGS. 4 and 5, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store a document data, image data, electronic database data, document templates, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like.

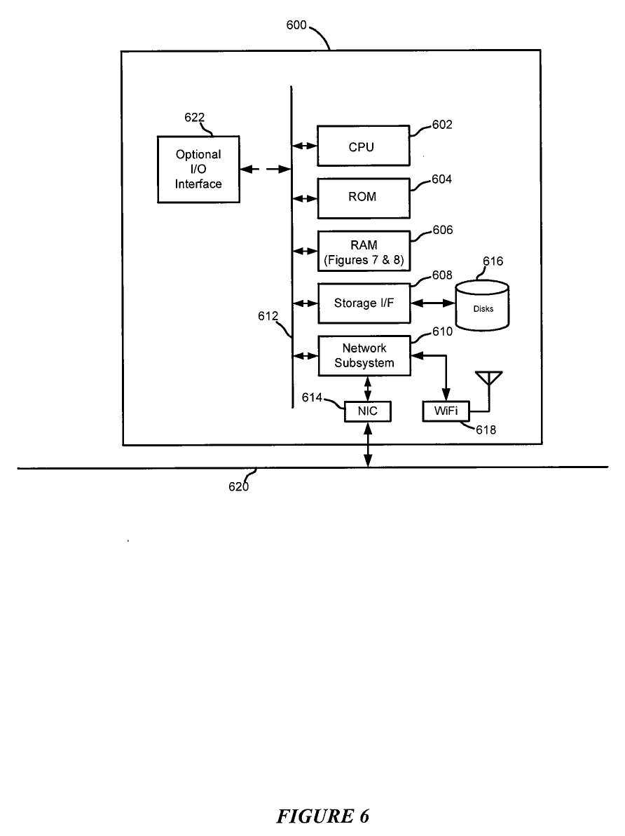

The system 100 illustrated in FIG. 1 further depicts a backend component 114, in data communication with the computer network 102 via a communications link 118. It will be appreciated by those skilled in the art that the backend component is shown in FIG. 1 as the backend server 114 for illustration purposes only. As will be understood by those skilled in the art, the backend server 114 is representative of any personal computing device known in the art, including, for example and without limitation, a computer workstation, a personal computer, laptop computer, a personal data assistant, a web-enabled cellular telephone, a smart phone, a proprietary network device, or other web-enabled electronic device, capable of hosting and communicating data with a plurality of electronic devices. The communications link 118 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. The functioning of the server 114 will better be understood in conjunction with the block diagram illustrated in FIG. 6, explained in greater detail below.

Coupled to the backend server 114 is a data storage device 116, storing pricing data relative to services offered by the document processing device 104, information regarding such services, and the like. In accordance with the preferred embodiment of the subject application, the data storage device 116 is any mass storage device known in the art including, for example and without limitation, magnetic storage drives, a hard disk drive, optical storage devices, flash memory devices, or any suitable combination thereof. According to one embodiment of the subject application, the server 114 is capable of functioning as an authentication server, thereby enabling the identification and authorization of services to a plurality of users. The skilled artisan will appreciate that the server 114 is further capable of storing account information relative to a plurality of users in the associated data storage device 116.

The system 100 of FIG. 1 further includes a data storage server 120, suitably functioning to store a plurality of document templates, previously stored documents, or the like, via the associated data storage device 122. In accordance with the one embodiment of the subject application, the data storage device 122 is any mass storage device known in the art including, for example and without limitation, magnetic storage drives, a hard disk drive, optical storage devices, flash memory devices, or any suitable combination thereof. It will be appreciated by those skilled in the art that the data stored on the data storage device 122 is capable of being accessed, via the computer network 102, by a user at the document processing device 104. The functioning of the server 120 will better be understood in conjunction with the block diagram illustrated in FIG. 6, explained in greater detail below.

Turning now to FIG. 2, illustrated is a representative architecture of a suitable device 200 on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the server 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 108 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with bus the 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, (shown in FIG. 1 as the controller 108) as an intelligent subsystem associated with a document processing device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for s communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a representative architecture of a suitable server 600, (depicted in FIG. 1 as the servers 114 and 120) on which operations of the subject system are completed. Included is a processor 602, suitably comprised of a central processor unit. However, it will be appreciated that processor 602 may advantageously be composed of multiple processors working in concert with one another as will be appreciated by one of ordinary skill in the art. Also included is a non-volatile or read only memory 604 which is advantageously used for static or fixed data or instructions, such as BIOS functions, system functions, system configuration, and other routines or data used for operation of the server 600.

Also included in the server 600 is random access memory 606, suitably formed of dynamic random access memory, static random access memory, or any other suitable, addressable memory system. Random access memory provides a storage area for data instructions associated with applications and data handling accomplished by the processor 602.

A storage interface 608 suitably provides a mechanism for volatile, bulk or long term storage of data associated with the server 600. The storage interface 608 suitably uses bulk storage, such as any suitable addressable or serial storage, such as a disk, optical, tape drive and the like as shown as 616, as well as any suitable storage medium as will be appreciated by one of ordinary skill in the art.

A network interface subsystem 610 suitably routes input and output from an associated network allowing the server 600 to communicate to other devices. The network interface subsystem 610 suitably interfaces with one or more connections with external devices to the server 600. By way of example, illustrated is at least one network interface card 614 for data communication with fixed or wired networks, such as Ethernet, token ring, and the like, and a wireless interface 618, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 614 is interconnected for data interchange via a physical network 620, suitably comprised of a local area network, wide area network, or a combination thereof.

Data communication between the processor 602, read only memory 604, random access memory 606, storage interface 608 and the network subsystem 610 is suitably accomplished via a bus data transfer mechanism, such as illustrated by bus 612.

Suitable executable instructions on the server 600 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 622 as will be appreciated by one of ordinary skill in the art.

In operation, user identification data is received corresponding to an associated user. A request is then received from the associated user for generation of a date range related document. Data range related content data is then received from an associated storage. Pricing data, associated with the received content data, is then received. Display data is then generated including a display corresponding to the received content data and the received pricing data. Selection data, corresponding to a selection of desired content data, is then received from the associated user. A data range document is then generated in accordance with the received selection data. Cost data is then generated according to the received selection data. The data range related document is then rendered by an associated document processing device.

In accordance with one example embodiment of the subject application, a document processing device 104, via a suitable user interface 106, receives identification data corresponding to an identity of an associated user. It will be appreciated by those skilled in the art that the user identification data is capable of including, for example and without limitation, an alpha-numeric character string, a password, biometric data, username, account number, or the like. In accordance with one embodiment of the subject application, an associated user accesses the document processing device 104 via a proximal kiosk (not shown), which comprises an input device and associated display. In such an embodiment, it will be understood by those skilled in the art that the kiosk is in data communication with the document processing device 104 and located in relatively close proximity thereto.

A determination is then made whether the identification data received from the user is valid, i.e., whether the user is authorized to use the services provided by the document processing device 104. In accordance with one embodiment of the subject application, the authentication is accomplished via the document processing device 104 transmitting the identification data to an authentication server, such as the backend server 114, which is capable of functioning as the authentication server. The backend server 114 would then compare the identification data to user identification stored in the data storage device 116 to determine authorization levels, account information, and the like with respect to the user. This data is then returned to the document processing device 104 indicating that the user is authorized to proceed with requesting document processing services from the document processing device 104. When the data returned from the authentication or backend server 114 indicates a negative authentication, the user is denied access. It will be appreciated by those skilled in the art that the authentication of the user is capable of being accomplished using user data stored locally to the document processing device 104, e.g., in the data storage device 110.

When the user is authenticated to request services, the controller 108 or other suitable backend component associated with the document processing device 104 then receives a data range related document generation request from the associated user. Preferably, the associated user inputs the date range related document generation request via the user interface 106. In accordance with one embodiment of the subject application, the generation request comprises a request for a template document, such as a seasonal calendar, card, poster, or the like. Thus, a determination is made by the controller 108 whether the user has requested the use of a template, including associated images, or a separate image, which the user is then prompted to upload. It will be appreciated by those skilled in the art that such an uploading is capable of being accomplished via a retrieval operation from the Internet, from an associated data storage device 110, via a portable storage media, or the like.

When the user does not desire to upload a custom image, the controller 108 or other suitable component of the document processing device 104 receives date range related content data from an associated data storage, such as, for example and without limitation the data storage device 110, the data storage device 116, the data storage device 122, or the like. In accordance with one embodiment of the subject application, the date range related content data includes, for example and without limitation image data and/or text data associated with a selected date range. The selected date range, as will be appreciated by those skilled in the art includes, for example and without limitation, a holiday, a calendar, a season, an occasion, motivational or religious event, or the like. For example, the content data is capable of comprising an image of a turkey and a text message of “Happy Thanksgiving”.

Pricing data is then received from the data storage device 110 or the device 116 corresponding to the content data received from storage. The skilled artisan will therefore appreciate that each image and/or text has an associated cost, which constitutes pricing data that is stored in the data storage device 110 or 116. When the user is uploading an image or custom text, the content is received from the user and pricing data is generated by the controller 108, or the server 114 corresponding thereto. Thereafter, once the pricing data and content data have been received by the controller 108, or other suitable backend component of the document processing device 104, a display is generated inclusive of the pricing data and the content data. Preferably, the display is generated via the user interface 106 such that the user is able to view pricing associated with each image and/or text component associated with the date range related document.

The user then selects desired content data via the user interface 106, whereupon the controller 108 directs a suitable component associated with the document processing device 104 to generate a date range related document incorporating the selected content data. The controller 108 or other suitable component of the document processing device 104 then generates cost data associated with the generated date range related document. That is, the controller 108 calculates the costs associated with outputting the date range related document incorporating the selected content data. It will be appreciated by those skilled in the art that the user is also able to select output media, colors, resolutions, and the like, typically associated with document output.

A display is then generated indicating the cost associated with outputting the date range related document to the user via the user interface 106. Thus, the user is prompted to select a payment method, such as, for example and without limitation, prepaid account, cash, credit card, coupon, or the like. This payment information, as received from the user, is then submitted to the appropriate financial institution, either directly from the document processing device 104, or via the backend server 114 for authorization. In accordance with one embodiment of the subject application, authorization is received from the user in the form of an acceptance of the costs, such as accepting charges to an account, insertion of currency, or the like. Once authorization is received, the rendering of the date range related document is then enabled at the document processing device 104, whereupon the document is output for the user. When such authorization is not received, the transaction is denied.

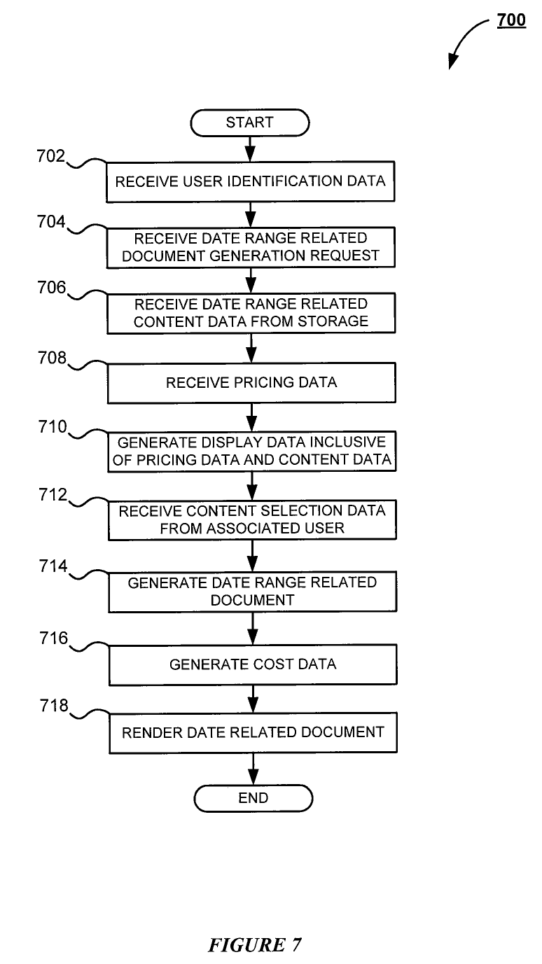

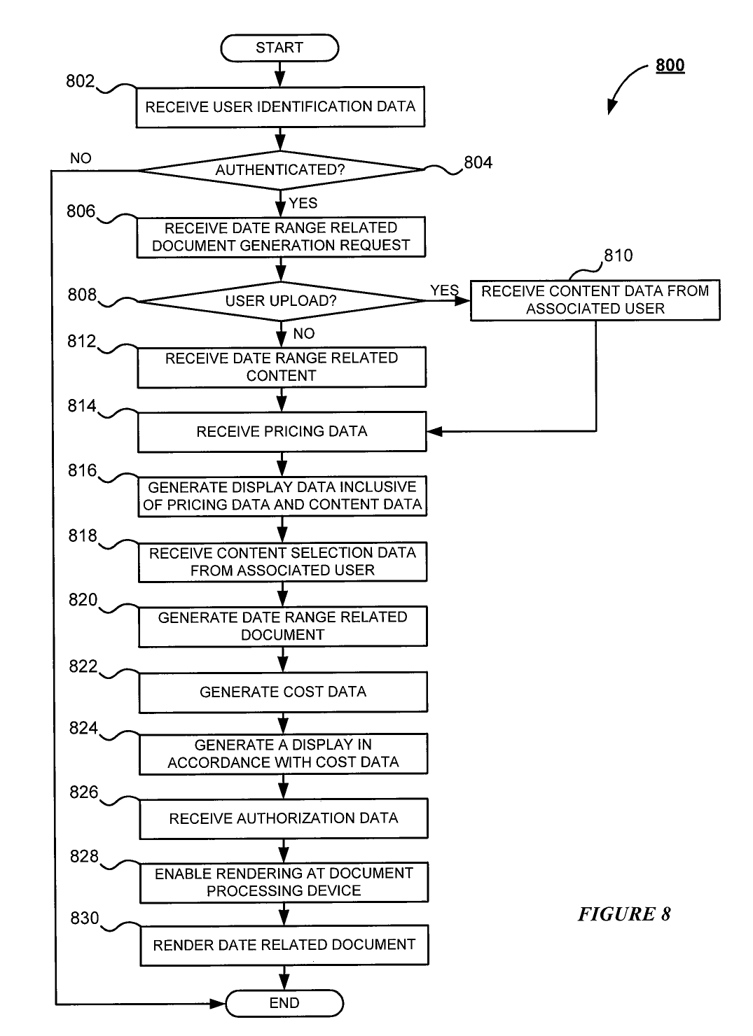

The skilled artisan will appreciate that the subject system 100 and components described above with respect to FIG. 1, FIG. 2, FIG. 3, FIG. 4, FIG. 5, and FIG. 6 will be better understood in conjunction with the methodologies described hereinafter with respect to FIG. 7 and FIG. 8. Turning now to FIG. 7, there is shown a flowchart 700 illustrating a method for generating date range related document in accordance with one embodiment of the subject application. Beginning at step 702, user identification data is received corresponding to an associated user. Preferably, the identification data is received from the user via the associated user interface 106 of the document processing device 104. In accordance with one embodiment of the subject application, the identification data includes, for example and without limitation, a username, password, biometric data, an alphanumeric sequence, or the like. A date range related document generation request is then received at step 704. It will be appreciated by those skilled in the art that in accordance with one embodiment of the subject application, the user inputs a date range related document generation request via the user interface 106 associated with the document processing device 104.

At step 706, date range related content data is received from an associated storage. Preferably, the controller 108 or other suitable component of the document processing device 104 retrieves content data from the data storage device 110, from the data storage device 116, or the data storage device 122 representative of image data and or text data corresponding to a selected date range, e.g., a holiday, a season, an occasion, or the like. At step 708, pricing data associated with the received content is received. A display is then generated at step 710 inclusive of the pricing data and the received content data. It will be understood by those skilled in the art that in accordance with one embodiment of the subject application, content data with associated pricing information is displayed to the user via the associated user interface 106.

At step 712, content selection data is received from the associated user representing a desired date range related content. A date range related document is then generated by the controller 108 or other suitable component associated with the document processing device 104 in accordance with the selection data at step 714. Cost data is then generated at step 716 corresponding to the received selection data. That is, the controller 108 or other suitable component of the document processing device 104, calculates the cost of producing the generated date range related document. Thereafter, the date range related document is rendered by the document processing device 104 at step 718.

Referring now to FIG. 8, there is shown a flowchart 800 illustrating an example implementation of the method for generating date range related document output in accordance with one embodiment of the subject application. It will be appreciated by those skilled in the art that the method depicted in FIG. 8 illustrates additional operations that are performed in accordance with this example implementation. Accordingly, the method illustrated in the flowchart 800 of FIG. 8 begins at step 802, whereupon user identification data is received by the document processing device 104 from an associated user. In accordance with this example embodiment, the user inputs a username, password, or the like via the user interface 106. A determination is then made at step 804 whether the user has been authenticated. Preferably, the controller 108 or other suitable component of the document processing device 104 compares the received identification data to identification data in storage. In accordance with one embodiment of the subject application, the document processing device 104 securely communicates the identification data to the backend server 114, which queries the data storage device 116 so as to authenticate the user, as will be understood by those skilled in the art. The server 114 then returns authentication or non-authentication data to the document processing device 104, hence the determination at step 804. When authentication has not been verified, the user is denied access and the operation terminates.

When authentication has been received by the document processing device 104, the user is able to subject a date range related document generation request at step 806. The user is then queried so as to determine whether the user desires to upload an image from portable storage at step 808. When it is determined at step 808 that the user does not desire to use a custom image, such as that which is capable of being stored on a portable storage device, flow progresses to step 812, whereupon the document processing device 104 receives date range related content data. In accordance with one embodiment of the subject application, the document processing device 104 stores content data locally, via the data storage device 110. According to another embodiment of the subject application, content data is stored remotely, such as at server 120. Thus, data is retrieved from the data storage device 122 and communicated, via the computer network 102, from the server 120 to the document processing device 104. Pricing data is then received at step 814 corresponding to received content data. The skilled artisan will appreciate that the pricing data is capable of being co-located with the content data on the data storage device 110 or 122, or alternatively on the data storage device 116 associated with the server 114, which is communicated to the document processing device 104 via the computer network 102. Thereafter, display data is generated inclusive of the pricing data and the content data at step 816.

Returning to step 808, when the user desires to upload a custom image, flow proceeds to step 810, whereupon custom content data is received from the user. It will be appreciated by those skilled in the art that such custom data is capable of being received via insertion or attachment of a portable storage media to the document processing device 104 and designation of such by the user via the user interface 106. Pricing data is then received corresponding to the custom image at step 814. Display data is thereafter generated at step 816 including the received custom content data and the pricing data. Preferably, the generated display data is viewed by the user via the user interface 106, as will be appreciated by those skilled in the art.

Content selection data is then received from the user at step 818 corresponding to desired content data for inclusion in the date range related document. The controller 108 then generates a date range related document in accordance with the selected content data at step 820. For example, when the user selects a greeting card, calendar, poster, or the like, the selected document is generated by the document processing device 104 using the content data selected, i.e., an image, text message, or a combination thereof. Based upon this generated date range related document, the controller 108 or other suitable component of the document processing device 104 calculates the cost associated with outputting the document at step 822. A display is then generated at step 824 in accordance with the cost generated by the controller 108 or other suitable component of the document processing device 104. In accordance with one embodiment of the subject application, the cost data is displayed to the user via the user interface 106 representing the expense of outputting the customized date range related document.

Authorization data is then received at step 826 representative of an authorization to proceed with processing the date range related document request. Preferably, the authorization includes, for example and without limitation, an acceptance of the charges by the user, an authorization from a financial institution, or the like. Suitable means of providing authorization include, for example and without limitation, charging a credit card or account, debiting a prepaid account, receiving a corresponding amount of currency, or the like. Once authorization has been received at step 826, rendering is enabled at the document processing device 104 at step 828. Thereafter, the document processing device 104 renders the date range related document at step 830. For example, after rendering has been enabled, the user is prompted, via the user interface 106, to enable the output of the document, e.g., by selecting an appropriate button or graphic displayed on or associated with the user interface 106.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for generating date range related document output comprising:
means adapted for receiving identification data corresponding to an associated user;
means adapted for receiving a request from the associated user for generation of a date range related document;
means adapted for receiving date range related content data from an associated storage;
means adapted for receiving pricing data associated with received content data;
means adapted for generating display data inclusive of a display corresponding to received content data and received pricing data;
means adapted for receiving selection data corresponding to the content data from the associated user;
means adapted for generating a date range document in accordance with received selection data;
means adapted for generating cost data in accordance with received selection data; and
rendering means adapted for rendering the date range related document.

2. The system for generating date range related document output of claim 1 wherein the content data include at least one of data from the set comprising image data and text data, and which data is associated with a selected date range.

3. The system for generating calendar-related document output of claim 2 wherein the selected date range corresponds to a holiday.

4. The system for generating calendar-related document output of claim 2 wherein the selected date range corresponds to calendar data.

5. The system for generating calendar-related document output of claim 2 further comprising:
means adapted for generating a display in accordance with generated cost data;
means adapted for receiving authorization data; and
means adapted for enabling the rendering means in accordance with received authorization data.

6. The system for generating calendar-related document output of claim 5 wherein the authorization data is received from at least one of the associated user and an associated financial institution.

7. A method for generating date range related document output comprising the steps:
receiving identification data corresponding to an associated user;
receiving a request from the associated user for generation of a date range related document;
receiving date range related content data from an associated storage;
receiving pricing data associated with received content data;
generating display data inclusive of a display corresponding to received content data and received pricing data;
receiving selection data corresponding to the content data from the associated user;
generating a date range document in accordance with received selection data;
generating cost data in accordance with received selection data; and
rendering the date range related document.

8. The method for generating date range related document output of claim 7 wherein the content data include at least one of data from the set comprising image data and text data, and which data is associated with a selected date range.

9. The method for generating calendar-related document output of claim 8 wherein the selected date range corresponds to a holiday.

10. The method for generating calendar-related document output of claim 8 wherein the selected date range corresponds to calendar data.

11. The method for generating calendar-related document output of claim 8 further comprising the steps:
generating a display in accordance with generated cost data;
receiving authorization data; and
enabling the rendering means in accordance with received authorization data.

12. The method for generating calendar-related document output of claim 11 wherein the authorization data is received from at least one of the associated user and an associated financial institution.

13. A computer-implemented method for generating date range related document output comprising the steps:
receiving identification data corresponding to an associated user;
receiving a request from the associated user for generation of a date range related document;
receiving date range related content data from an associated storage;
receiving pricing data associated with received content data;
generating display data inclusive of a display corresponding to received content data and received pricing data;
receiving selection data corresponding to the content data from the associated user;
generating a date range document in accordance with received selection data;
generating cost data in accordance with received selection data; and
rendering the date range related document.

14. The computer-implemented method for generating date range related document output of claim 13 wherein the content data include at least one of data from the set comprising image data and text data, and which data is associated with a selected date range.

15. The computer-implemented method for generating calendar-related document output of claim 14 wherein the selected date range corresponds to a holiday.

16. The computer-implemented method for generating calendar-related document output of claim 14 wherein the selected date range corresponds to calendar data.

17. The computer-implemented method for generating calendar-related document output of claim 14 further comprising the steps:
generating a display in accordance with generated cost data;
receiving authorization data; and
enabling the rendering means in accordance with received authorization data.

18. The computer-implemented method for generating calendar-related document output of claim 17 wherein the authorization data is received from at least one of the associated user and an associated financial institution.
